(19) United States
(12) Patent Application Publication
(10) Pub. No.: US 2015/0347979 A1
(43) Pub. Date: Dec. 3, 2015

(54) SOCIAL CALENDAR EVENT SHARING

(71) Applicant: Microsoft Corporation, Redmond, WA (US)

(72) Inventors: Doreen Nelson Fasen, Kirkland, WA (US); Joe Keng Yap, Sammamish, WA (US); Matthew McFadden, Seattle, WA (US)

(73) Assignee: Microsoft Corporation, Redmond, WA (US)

(21) Appl. No.: 14/289,029

(22) Filed: May 28, 2014

(51) Int. Cl. G06Q 10/10; H04L 29/08; G06Q 50/00; G06F 17/30

(52) U.S. Cl. CPC G06Q 10/1095; G06F 17/30876; H04L 67/02; G06Q 50/01

(57) ABSTRACT

Social calendar event sharing is described. An event associated with a personal calendar can be shared as a link to a subscription to the event. One instance of the event details can be managed by a social calendar event sharing service that receives the event details, stores the event details associated with the personal calendar of the event organizer, and generates the link. The link can be used by anyone to access the event details and add the event their own personal calendars. The event details are provided as a subscription to the event so that an update to the event can be propagated to the subscribers that have added the event to their calendars.

### BACKGROUND

Information can be disseminated through social media and more traditional channels of communication such as television, newspapers and magazines, email and other messaging services, phone, and in-person. Social calendars, particularly those made available to the public or a segment of the public (e.g., via a website or social media site), can be used to announce events and may even enable a viewer of the social calendar to add the event to their own calendar.

However, sharing and disseminating information about an event while maintaining some control over the event can be a challenge for an organizer of the event. For example, when the organizer uses a one-way channel of communication such as by posting or advertising an event, it can be difficult to obtain feedback as to the number of people viewing the event, and even whether someone may attend, unless each person specifically notifies the organizer. When the organizer uses a two-way channel of communication, such as in-person or email, the organizer is generally limited to the specific people to which the communication was provided. Even when using email, it can be difficult to obtain feedback or maintain control over the invitation and event when the recipients use different clients or applications and certain properties of the invitation are not utilized (or are lost).

### BRIEF SUMMARY

Systems and techniques for social calendar event sharing are provided. Information about a specific event can be disseminated over a variety of platforms through a link to a subscription to the specific event. The link may be generated by a social calendar event sharing service, which can receive the specific event details and store those details associated with the organizer's personal calendar. When the link is “clicked,” a user can add the event to their personal calendar and a subscription to the specific event may be established.

Through the social calendar event sharing as described herein, it is possible to maintain a connection between those that view the event and the organizer of the event regardless of what calendar service they use. For example, when the event is modified or otherwise updated by the event organizer, the social calendar event sharing service can propagate the change to the subscribers of the event.

The social calendar event sharing service can also provide feedback to the event organizer that is platform independent. Regardless of the application or client that a person uses to access the event details or even to add the event to their personal calendar, the social calendar event sharing service can provide feedback of the access and/or adding to calendar of potential attendees.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIGS. 1A-1C illustrate example scenarios for creating a sharable event.

FIG. 2 illustrates an operating environment in which various implementations of social calendar event sharing may be carried out.

FIGS. 3A and 3B illustrate example scenarios for social calendar event sharing.

FIGS. 4A-4C illustrate example process flow diagrams for social calendar event sharing.

FIG. 5 illustrates a block diagram of components of systems that may be used to implement the techniques described herein.

FIG. 6 illustrates a system architecture of an example implementation.

### DETAILED DESCRIPTION

Systems and techniques for social calendar event sharing are provided. Through a social event calendar sharing service as described herein, a calendar event that is associated with an organizer's personal calendar can be made available for sharing and adding to potential attendees' personal calendars. Information about an event can be disseminated over a variety of platforms through a link to a subscription to the event. The subscription can be to a single event rather than an entire calendar.

A link, also referred to as a hyperlink, is an interactive element that has an anchor within the document in which the link is located and a target to which the link leads. A link is a representation—which may be active text or a graphic—that can be interpreted by a program to direct a user from one thing to another thing. Some links, such as available through the social calendar event sharing service described herein, are to active things, for example, to a bit of code that is then executed to perform a certain action. A common active thing to which a link directs is an ‘unsubscribe’ link for an email list that a user may click to have their email removed from an email list.

A user can follow a link by activating its anchor in some way (e.g., by clicking on it). Each link may include a uniform resource locator (URL) that, when selected, causes a browser or other application to request, retrieve, and render the event details in a viewing window.

A URL's format is based on Unix file path syntax, where forward slashes are used to separate directory or folder and file or resource names. Every URL consists of some of the following: the scheme name (commonly called protocol), followed by a colon, then, depending on the scheme, a domain name (alternatively, Internet Protocol (IP) address), a port number, the path of the resource to be fetched or the program to be run, a query string, and an optional fragment identifier. The syntax of a URL is generally scheme://domain:port/path?query_string#fragment_id. In some cases, the link may include a shortened URL, such as available through URL shortening services like Bitly® and TinyURL™.

Traditionally, sharing an event is sharing a copy of the event, typically in iCalendar format (.ical; .ics; .ifb; .icalendar), and once a copy is made, it is not always possible to control the copy—whether for updating the information about the event or to know who is seeing/receiving the information about the event. For example, in a calendaring application (such as part of Microsoft Outlook®), when an organizer of an event in which one or more recipients have been invited updates the event, the update generates a new copy of the event that is disseminated only to those recipients that had accepted the meeting invitation. Disseminating this information beyond those recipients is not automatic. For the scenario in which the event is published, for example, through publishing a calendar (such as via Google Calendar and iCalShare), users may be able to save a copy of the calendar; however, these tend to be entire calendars, not just one event and a user may not receive updates to the calendar unless the user subscribes to a service that issues new copies when there is an update (such as available through iCalShare).

Sharing an event can be accomplished by sending a link to an event instead of a copy of the event. The creation of the link can be part of the process for creating a new calendar item for a personal calendar so that the new calendar item (sometimes referred to as a “meeting” or an “appointment”) becomes a publically consumable resource that is accessible across platforms and clients. The terms “publish” and “share” may be used interchangeably herein to refer to making the event information available—or otherwise consumable—to the public (or a subset of the public).

In some cases, anyone may access the event information via the link and the link may be shared by anyone. In some cases, the event can be added to anyone's own calendar—not as a copy, but as a live instance. When the organizer makes a change to the event, the change is made at the instance stored by the service and, thus, any view of the event by those that added the event to their calendar. In some cases, those that have added the event may receive updates such as available by a subscription service.

As described herein, a sharable event can be created from a user's personal calendar—whether it is a personal calendar managed by a stand-alone calendar application, a calendar application that is part of a larger personal information management system, or a calendar-related function of a social media application.

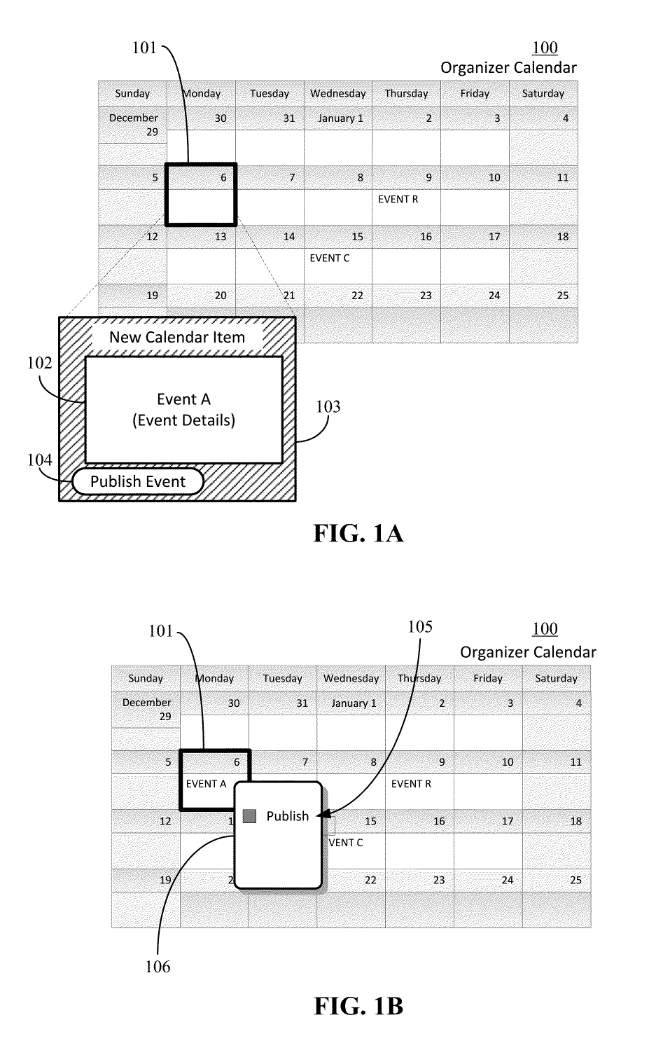

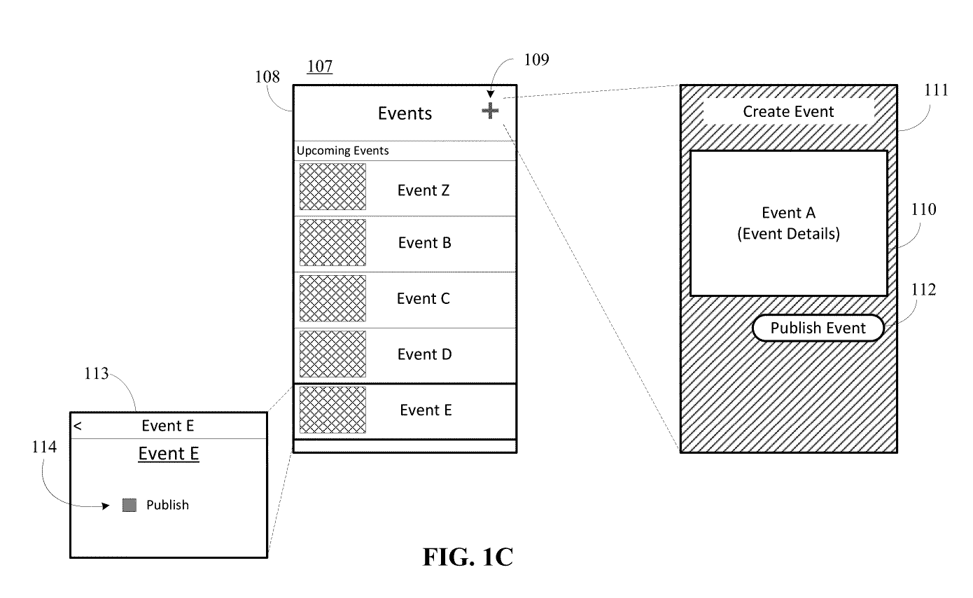

FIGS. 1A-1C illustrate example scenarios for creating a sharable event. The publishing of the event—for sharing the event—can initiate a number of actions, one of which is the generation of a link to the event. As part of generating the link to the event, the event details are stored in a manner that associates the event details with the event organizer's personal calendar (and viewable within the organizer's personal calendar).

According to certain implementations, a single instance of the event can be created by an organizer, and a link is generated to the single instance of the event. The organizer can then share the event through sharing the link. Not only can people view the event information, but they can add the event to their calendars and share with others while the organizer maintains a connection to the information being disseminated.

In some cases, the link is generated and simply provided to the organizer for the organizer to make available. In some cases (alternatively or in addition), the link is provided to a search engine's search index. Examples of search engines to which the link may be shared include, but are not limited to Bing®, Google®, Yahoo! ®, Baidu®, and Naver®.

Referring to FIG. 1A, a sharable event can be created as a new calendar item is being entered to an organizer's personal calendar 100. For example, while within a calendar application, a new calendar item may be created, for example by selecting a calendar entry 101, and event details 102 entered through a calendar item entry interface 103.

A calendar application may include components that are local (at a user's device) and components that are residing on a server, which can provide access and syncing of calendar items across multiple devices and/or storage of the user's calendar items. In some cases, the calendar application is part of a larger personal information management service that forms a coordinated storage system for more than one user.

In various implementations, the calendar application may be a rich client on a desktop or laptop (e.g., Microsoft Outlook®), a mobile client on a mobile device (e.g., a calendar application on the Android OS®, iCal for iOS®, Outlook® for Windows Phone®, or Cal from Any.do), or part of an application running as cloud services accessible via a web browser (e.g., Google® Calendar, Microsoft® Outlook Web App (OWA)).

In some cases, an organizer can indicate that an event is to be published when selecting to add a new calendar item to their personal calendar (e.g., as part of the command to launch a new calendar item entry interface 103). In some cases, a menu command 104 for publishing the event may be available as part of the calendar item entry interface 103.

Referring to FIG. 1B, an event associated with a personal calendar can be shared after it is created. For example, a user may publish an event listed as part of a calendar entry 101 by selecting a command 105 that may be part of a menu 106 available to the calendar item for the event.

Referring to FIG. 1C, a sharable event can be created in a social media application 107 from, for example, a calendar-related function of the social media application 107. An example of a social media application with a calendar-related function is Facebook®. The social media application 107 can include an events listing 108. A user may create a shareable event as a new event is added to the events listing 108. For example, a user may select to add an event 109 and enter new event details 110 via an event entry interface 111. As with the examples described with respect to FIG. 1A, the event can be published through a menu command 112 or automatically as a result of the original selection to add a new event (109). An existing event may also be published from the event page 113, for example through a publish command 114, such as described with respect to FIG. 1B.

Any of the applications from which an organizer creates a sharable event may communicate with the social calendar event sharing service to generate a link and store the event details associated with the organizer's personal calendar.

Through social calendar event sharing as described herein, sharing an event maintains a connection between potential attendees and the organizer of the event that is independent of platform. That is, a feedback loop can be established for the organizer even if a recipient's client application does not include the capabilities for returning a response to the organizer. For example, a meeting invitation to a Gmail™ account from a Microsoft Outlook® account may not return an indication of acceptance of the meeting event to the Microsoft Outlook® account.

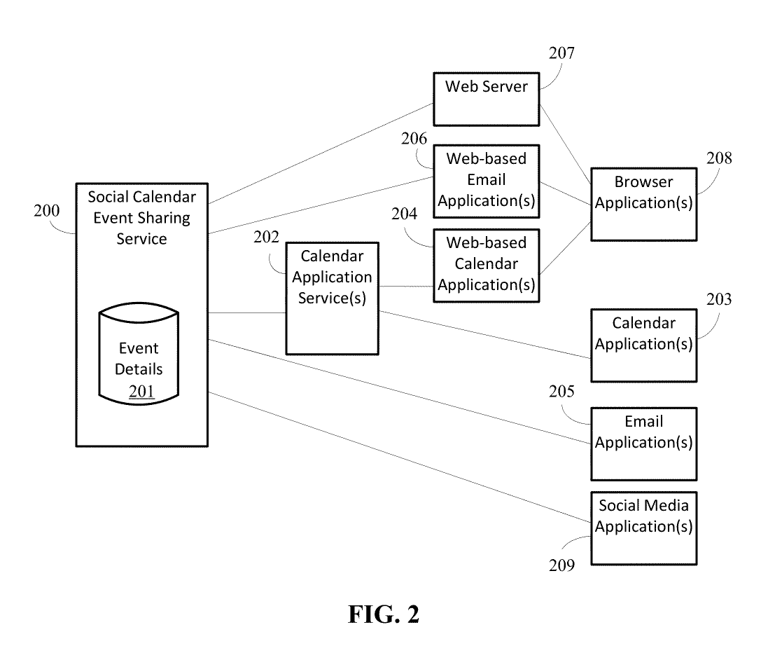

FIG. 2 illustrates an operating environment in which various implementations of social calendar event sharing may be carried out. Referring to FIG. 2, a system and service, indicated as social calendar event sharing service 200, can be provided in which an instance of an event can be stored (e.g., in an event details database 201), a link can be generated to the instance of the event, and the event can be tied to the organizer's calendar.

The social calendar event sharing service 200 can interact with various systems and platforms—both for an event organizer and for other users. Some example applications with which the social calendar event sharing service can communicate with include, but are not limited to a calendar application service(s) 202, native calendar application(s) 203, web-based calendar application(s) 204, email application(s) 205, web-based email application(s) 206, web server(s) 207, browser application(s) 208 and social media application(s) 209.

The various applications and services may communicate with each other using application programming interfaces (APIs) to send requests and receive information.

An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. An API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic.

The API-calling component may be a local component (i.e., on the same data processing system as the API-implementing component) or a remote component (i.e., on a different data processing system from the API-implementing component) that communicates with the API-implementing component through the API over a network. An API is commonly implemented over the Internet such that it consists of a set of Hypertext Transfer Protocol (HTTP) request messages and a specified format or structure for response messages according to a REST (Representational state transfer) or SOAP (Simple Object Access Protocol) architecture.

The network can include, but is not limited to, a cellular network (e.g., wireless phone), a point-to-point dial up connection, a satellite network, the Internet, a local area network (LAN), a wide area network (WAN), a WiFi network, an ad hoc network, an intranet, an extranet, or a combination thereof. The network may include one or more connected networks (e.g., a multi-network environment) including public networks, such as the Internet, and/or private networks such as a secure enterprise private network.

As mentioned above, a calendar application 202, native calendar application 203 or web-based calendar application 204, can communicate with the social calendar event sharing service 200 upon a user's creation of a calendar item so that the calendar event is stored by the service associated with that user.

The social calendar event sharing service 200 can then generate a link, for example a URL, and provide that link back to the calendar application (e.g., calendar application 202, native calendar application 203 or web-based calendar application 204). The organizer of the event can then provide that link through any suitable communication medium or social network to share the event. For example, the user may send the link via email or other messaging application. As another example, the user may share the link through Twitter® or Facebook®.

Accordingly, people may receive or access the link to a shared event through email or other messaging modalities, from visiting a website, or from a social media post, as some examples.

In some cases, an invitation to an event may be received via an email application (e.g., native email application 205 or web-based email application 206 accessed via the user's browser application 208) or some other messaging application.

In some cases, users may come across an event through a website (hosted by a web server 207) rendered via a browser application 208 running at a user's computing device. In some cases, users may come across an event through social media 209.

In some cases, a user may come across an event that they would like to add to their personal calendar when looking at a shared calendar, which may be viewable via the user's calendar application (e.g., a native calendar application 203 or a web-based calendar application 204 accessed via the user's browser application 208).

Then, regardless of the platform by which the user comes across the event, the user may add the event to their calendar by clicking on the link to the event. The request to the link is served by the social calendar event sharing service 200, bringing the feedback loop to a close.

Indeed, the service 200 can provide a subscription to a specific calendar event to a subscriber; and can provide feedback to the owner of the specific calendar event. The service can include various mechanisms to track user interactions with the event details for the specific calendar event. That is, the server system may implement one or more mechanisms to collect feedback data on dissemination of event details. Some mechanisms can involve embedding or referencing client-side scripts (e.g., code written in JavaScript, VBScript, ActionScript, and so on) within event detail information sent to client devices or the servers accessing the event details. Some mechanisms can involve using an intermediate server to gather and redirect requests for the event details (and the subscriptions to the events). Other mechanisms may be carried out by the server system so that requests for event details are tracked at the server system.

For example, it is possible to track who and/or how many viewed or added an event. Any suitable method for tracking unique visits, link clicks, and subscribers may be used. The elements that may be tracked include but are not limited to one or more of that the event has the subscriber (e.g., the event was added to a personal calendar), that the event received a ‘click’, that the event received a ‘view’, and, depending on the privacy scope of the platform and/or authorization of the subscriber, who the subscriber is (e.g., those on a same corporate network as the organizer may provide specific details).

The tracking information can be provided to the organizer. For example, it can be possible for an organizer to obtain feedback on how many people have seen the event, how many people indicated that they will attend, or how many people added the event to their calendars. This information can help the organizer with event preparation as well as whether they are promoting or marketing their events appropriately. Advantageously, through the social calendar sharing service, feedback can be provided to an organizer regardless of the platforms on which the public/invitees are using to receive the invitation to the social event. That is, even though some platforms may not support feedback (e.g., such as in an exchange between a user of Google Calendar and a user of Microsoft Outlook), the organizer can still receive feedback on whether the event was added.

The ability to generically share the link can let an event go “viral” while the described feedback mechanisms enable the original organizer to receive feedback of the viral coverage (e.g., who and/or how many people have viewed and/or added the event to their own calendars).

In some cases, aspects of the social calendar event sharing service can be made available to third parties to facilitate the sharing of events. A third party can use certain functions of the service to provide feedback to an organizer of publically shared events and to enable people to add specific events to their own personal calendars. Third parties can include publish event functionality by accessing the API of the social calendar event sharing service. Thus, the calendar event sharing service can receive requests from any application or service to generate a link in response to receiving calendar event details.

As one example, a third party application can interface with the social calendar event sharing service to manage event information on behalf of the third party application. The social calendar event sharing service can be used to store the event details so there is a single instance of the event and the third party application can provide a layer between client applications and the social calendar event sharing service.

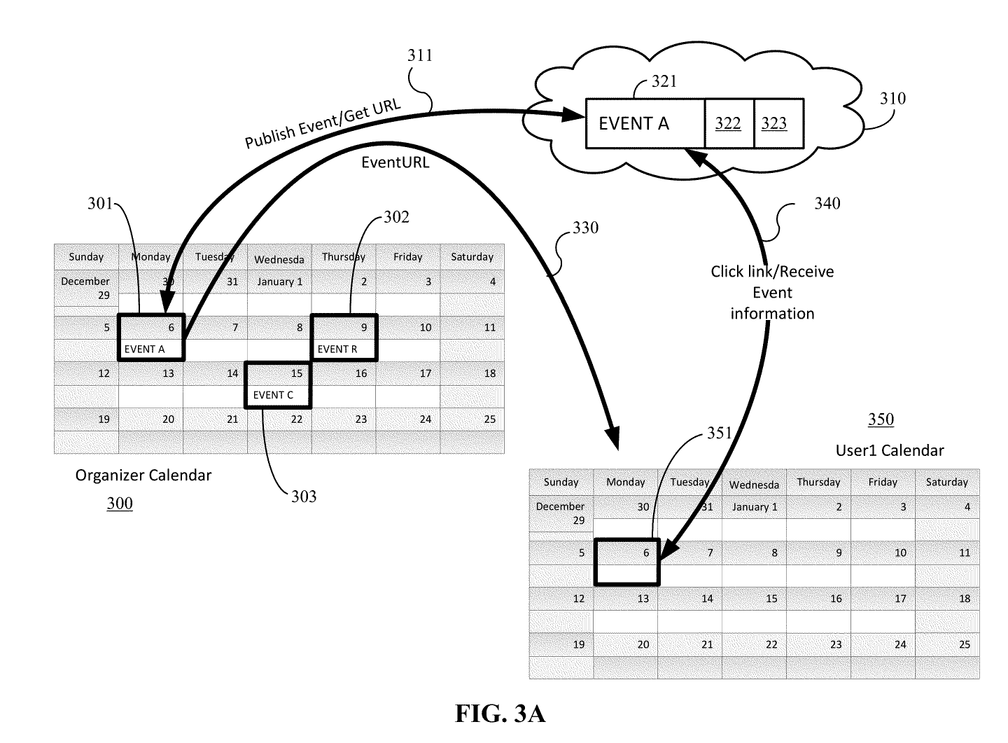

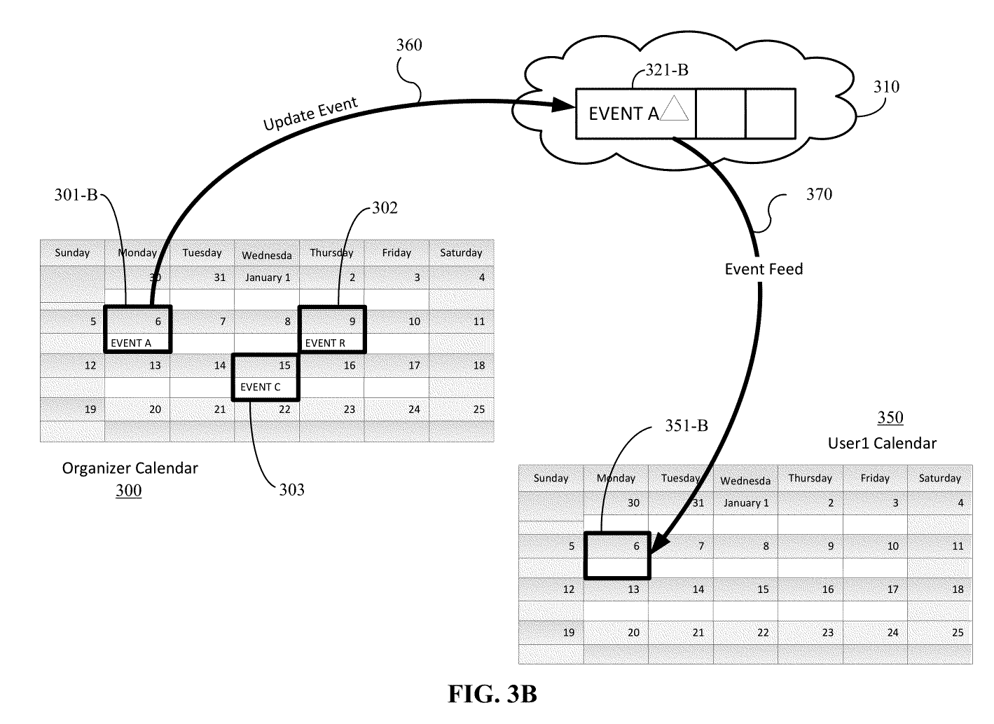

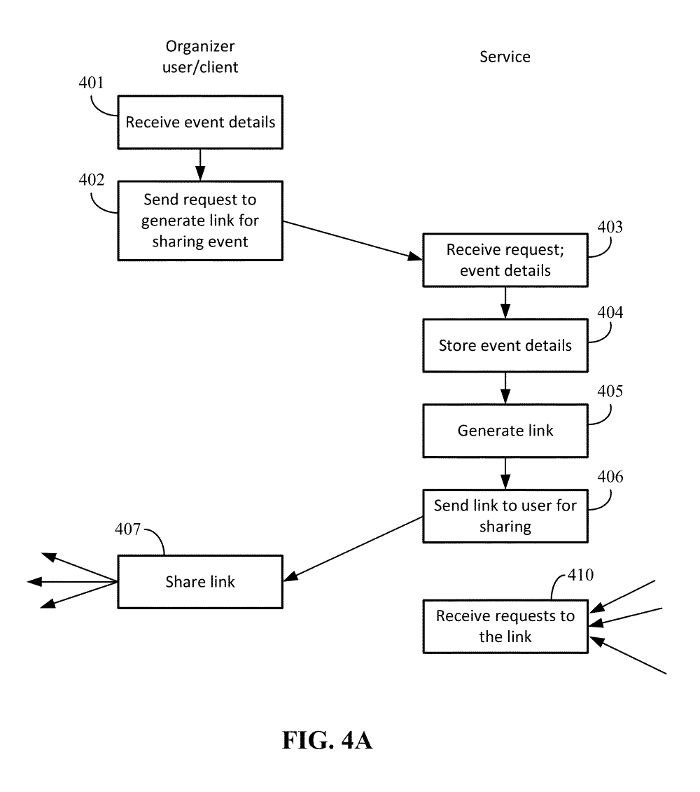

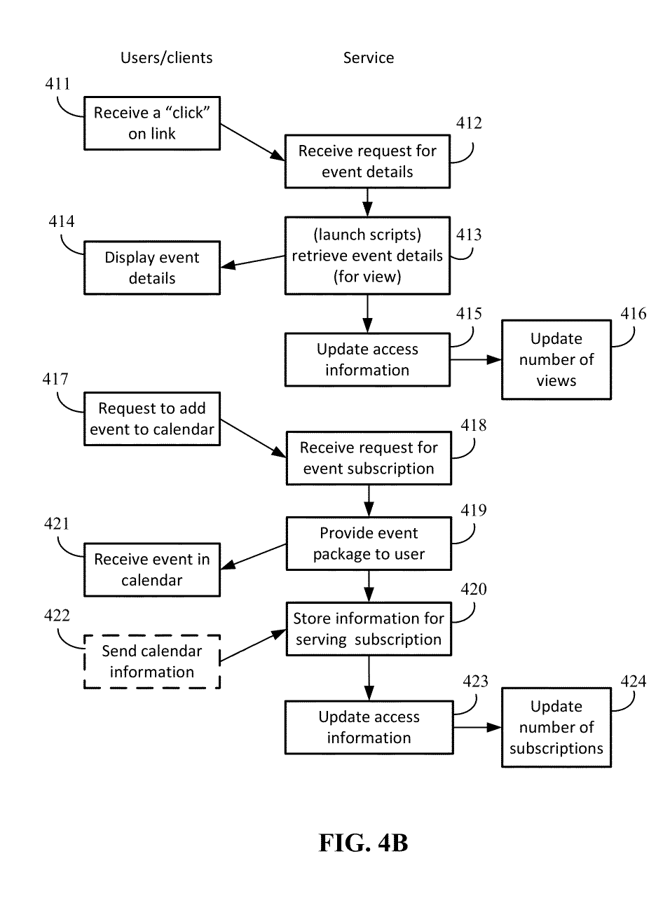

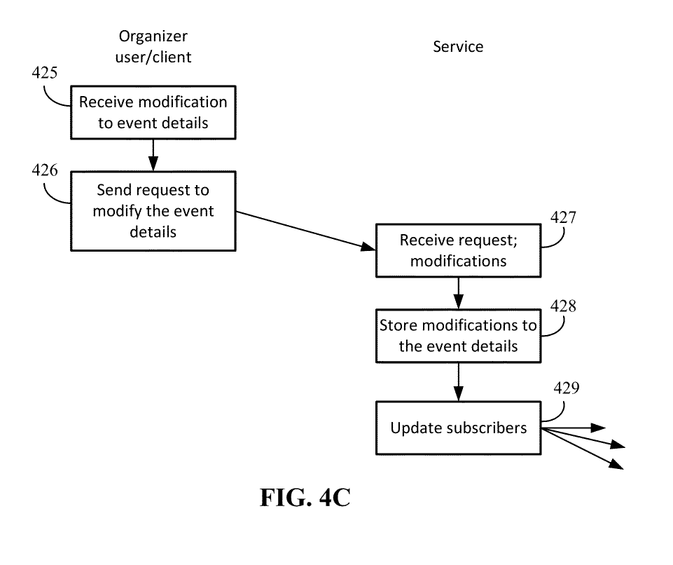

FIGS. 3A and 3B illustrate example scenarios for social calendar event sharing; and FIGS. 4A-4C illustrate example process flow diagrams for social calendar event sharing.

Referring to FIG. 3A, an organizer's personal calendar 300 may include a number of events (e.g., Event A 301, Event R 302, Event C 303). As an example scenario, the organizer may be an owner of a restaurant and the calendar 300 may be a calendar used to manage staff, create events staff can see as part of staffing activities, and publish a specific event for promotional use. In some cases, the restaurant owner may make an entire calendar available for promotional use. Advantageously, the subject social calendar event sharing service and techniques described herein enable the calendar itself to remain private or semi-private while allowing a single event to be shared to the public. That is, it is possible to publish a single event from a calendar.

For example, Event A 301 can be published while Events R 302 and C 303 may not be made available to the public. In some implementations, the event A 301 can become a shareable event by publishing to a social calendar event sharing service 310, for example as illustrated in FIGS. 1A-1C. An implementation of this process and communication 311 between the organizer's calendar application and the social calendar event sharing service 310 is illustrated in FIG. 4A. Referring to FIG. 4A, the calendar application can receive the event details (401) and send a request to the social calendar event sharing service 310 to generate a link for sharing the event (402). The service 310 can receive the request and the event details (403). The service 310 can the store the event details (404), for example, in an associated database, table, or other data structure (e.g., as Event A details 321) along with information about the organizer and personal calendar to which the event details belong (e.g., associated personal calendar information 322). The service can also store access information 323 associated with the Event A details 321. In addition to storing the event details (404), the service 310 can generate a link for the event (405).

The link can be provided to the organizer (406), who may then share the link 330 in any manner (407). In some cases, the calendar event sharing service 310 can make the link available to various search engines and/or communicate with another service that promotes or otherwise distributes the event information (e.g., an email marketing service). In some cases, the organizer's calendar application can, based on the user's selection to publish the event, programmatically make the link available to various search engines and/or communicate with another service that promotes or otherwise distributes the event information in response to receiving the link from the calendar event sharing service.

Requests to the link can be received by the service (410). An implementation of this process and communication 340 between the user's calendar application and the social calendar event sharing service 310 is illustrated in FIG. 4B. Referring to FIG. 4B, when someone clicks on the link (411), the service 310 receives a request for event details (412) and initiates a process that enables a user to add the event to their own calendar 350. For example, in response to receiving a request via the link (412), scripts can be executed that enable a user that clicked the link to add the event details as a calendar item 351 to a particular destination such as their own personal calendar 350. The destination may be any type of personal calendar that can communicate with the social calendar event sharing service to receive the event information feed. As part of the process, the service can retrieve the event details 321 (413), for example, from the database or table (or other data structure).

A graphical user interface (not shown) may be rendered at the user's device that displays the event details (414) and provides the user with an option to add the event to a particular calendar available for the user. The social calendar event sharing service 310 can, as part of providing feedback to the event organizer, update the access information 323 for the event (415), for example, by updating the number of views (416). In some cases, the person viewing the event details does not do anything further. In other cases, the person viewing the event details selects to add the event to one (or more) of their personal calendars (417). The person may select to add the event via the graphical user interface rendered at the user's device. In some cases, the graphical user interface may appear similar to a meeting invitation as typical in many calendar applications, where an “accept,” “tentative,” and “decline” option is available.

The service receives the request to add the event to a calendar as a request for a subscription to the event (418) and provides the event package to the user (419), which enables the user to receive the event information in their designated calendar 350 (421). As part of the request, or in response to receiving the event information for the calendar, the user's calendar application can send calendar information to the service (422) so the service may store the user's calendar information for serving (or otherwise providing) the subscription (420). The subscription provides the event details and “pushes” or otherwise makes available any changes to that specific event. How that data is interpreted and presented to the recipient can vary depending on the particular application and/or client receiving that data. In some cases, the subscription can be provided in a Really Simple Service (RSS) feed interchange format.

The social calendar event sharing service can, as part of providing feedback to the event organizer, update the access information 323 for the event (423), for example, by updating the number of subscription (424).

The organizer of the event can keep track of how many people may be aware of the event and/or are planning to attend the event through the feedback available from the social calendar event sharing service 310. In some cases, the feedback may be available as part of a feed to the organizer's calendar application 300 (for display along with the organizer's event) that sends updates periodically or under certain conditions (such as each time the access information 323 is updated or when a certain number of additional views and/or subscriptions have been received). In some cases, the feedback may be available upon request of the organizer (or an application the organizer is using).

Referring to FIGS. 3B and 4C, the service 310 maintains the association between the organizer's personal calendar 300 and the event 321 so that when the organizer makes a modification to the event details (301-B), for example while within the organizer's calendar application, the calendar application receives the modification to the event details (425) and sends a request 360 to modify the event details to the service (426). The social calendar event sharing service 310 receives the request and the modifications (427) and stores the modifications to the event details (428) so that the event details may be updated (as 321-B). The service 310 can then update the event information 351-B for the subscribers (429), for example, as part of a feed 370 to the subscriber calendars.

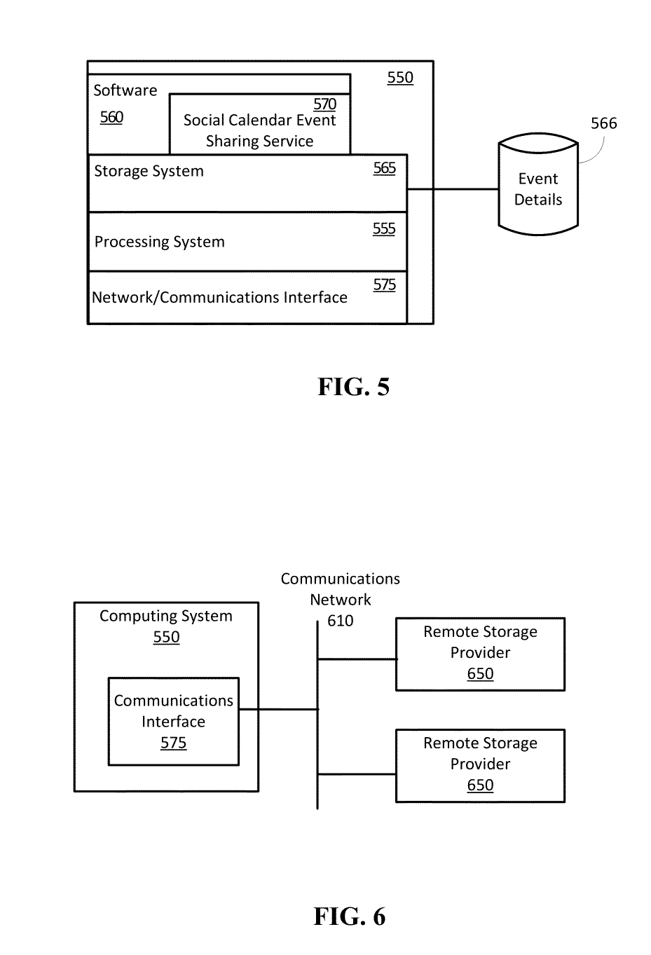

FIG. 5 illustrates a block diagram of components of systems that may be used to implement the techniques described herein. Although specific detail is provided for systems on which the social calendar event sharing service 200, 310 may be embodied, various components are applicable to client devices (e.g., laptop, phone, wearable computer, smart television, game console, and the like) from which an organizer and/or user may interact with the social calendar event sharing service.

Referring to FIG. 5, system 550 may be implemented within a single computing device or distributed across multiple computing devices or sub-systems that cooperate in executing program instructions. The system 550 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 550 can include a processing system 555, which may include one or more processors and/or other circuitry that retrieves and executes software 560 from storage system 565. Processing system 555 may be implemented within a single processing device but may also be distributed across multiple processing devices or sub-systems that cooperate in executing program instructions.

Examples of processing system 555 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

Storage system 565 can include any computer readable storage media readable by processing system 555 and capable of storing software 560. Storage system 565 may include volatile and nonvolatile, removable and non-removable media implemented in any method or technology for storage of information, such as computer readable instructions, data structures, program modules, or other data. Examples of storage media include random access memory, read only memory, magnetic disks, optical disks, CDs, DVDs, flash memory, virtual memory and non-virtual memory, magnetic cassettes, magnetic tape, magnetic disk storage or other magnetic storage devices, or any other suitable storage media. In no case is the storage medium a propagated signal or carrier wave.

In addition to storage media, in some implementations, storage system 565 may also include communication media over which software may be communicated internally or externally. Storage system 565 may be implemented as a single storage device but may also be implemented across multiple storage devices or sub-systems co-located or distributed relative to each other. Storage system 565 may include additional elements, such as a controller, capable of communicating with processing system 555. In some cases, storage system 565 includes resources for an event details database 566. In other cases, the resources for the event details database 566 are part of a separate system with which system 550 communicates, such as shown in FIG. 6.

As illustrated in FIG. 6, data, such as event detail data, may be stored on any number of remote storage platforms 650 that may be accessed by the system 550 over communication networks 610 via the communications interface 575. Such remote storage providers might include, for example, a server computer in a distributed computing network, such as the Internet. They may also include “cloud storage providers” whose data and functionality are accessible to applications through OS functions or APIs.

Software 560, including a social event calendar sharing application and service 570, may be implemented in program instructions and among other functions may, when executed by system 550 in general or processing system 555 in particular, direct the system 550 or processing system 555 to operate as described herein for social event calendar sharing.

Software 560 may also include additional processes, programs, or components, such as operating system software or other application software. It should be noted that the operating system may be implemented both natively on the computing device and on software virtualization layers running atop the native device operating system (OS). Virtualized OS layers, while not depicted in FIG. 5, can be thought of as additional, nested groupings within the operating system space, each containing an OS, application programs, and APIs.

Software 560 may also include firmware or some other form of machine-readable processing instructions executable by processing system 555.

System 550 may represent any computing system on which software 560 may be staged and from where software 560 may be distributed, transported, downloaded, or otherwise provided to yet another computing system for deployment and execution, or yet additional distribution.

In embodiments where the system 550 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 575 may be included, providing communication connections and devices that allow for communication between system 550 and other computing systems over a communication network or collection of networks or the air. Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface can be controlled by the OS, which informs applications of communications events when necessary.

It should be noted that many elements of system 550 may be included in a system-on-a-chip (SoC) device. These elements may include, but are not limited to, the processing system 555, the communications interface 575, and even elements of the storage system 565.

Certain aspects of the invention provide the following non-limiting embodiments:

### Example 1

A method facilitating social calendar event sharing, the method comprising: generating a link to a specific calendar event that is associated with a first personal calendar; and responsive to receiving a request to add the specific calendar event to a second personal calendar via the link, providing a subscription to the specific calendar event for the second personal calendar. The method can be performed by one or more processors in communication with one or more storage devices as a standalone service or integrated with a calendar service. The subscription to the specific calendar event can be programmatically established through the link.

### Example 2

A method according to example 1, further comprising: receiving event details for the specific calendar event and a request to publish the specific calendar event, the generating of the link being performed in response to the request to publish the specific calendar event; and storing the event details for the specific calendar event. The event details can be stored in a database or other data structure.

### Example 3

The method according to examples 1 or 2, further comprising: in response to receiving a modification of the event details for the specific calendar event, storing the modification of the event details for the specific calendar event and publishing the modification to the subscription.

### Example 4

The method according to any of examples 1-3, wherein the second personal calendar is managed by a platform different than that of the personal calendar to which the specific calendar event is associated.

### Example 5

The method according to any of examples 1-4, wherein the link is not to a webpage.

### Example 6

The method according to any of examples 1-5, wherein the link is not to an iCalendar format file.

### Example 7

The method according to any of examples 1-6, further comprising: tracking at least one of views of the specific calendar event and subscriptions to the specific calendar event; and providing results of the tracking as feedback to an owner of the specific calendar event.

### Example 8

The method according to example 7, wherein the feedback is platform independent.

### Example 9

The method according to example 7 or 8, wherein the feedback is received from multiple clients of at least two platforms.

### Example 10

A system comprising: a social event calendar sharing service stored on one or more computer readable storage media that, when executed by a processing system: receives an indication to generate a link to an event associated with a personal calendar and event details of the event; stores the event details and generates the link; stores an access indication for each access condition for the event details via the link; and provides the access indication to an event owner.

### Example 11

The system according to example 10, wherein the access condition comprises at least one of a view of the event details, a click on the link, and a subscription to the event.

### Example 12

The system according to example 10 or 11, wherein the access indication comprises at least one of a number of views of the event details, a number of clicks on the link, and a number of subscriptions to the event.

### Example 13

The system according to any of examples 10-12, wherein the link is not to a webpage.

### Example 14

The system according to any of examples 10-13, wherein the link is not to an iCalendar format file.

### Example 15

The system according to any of examples 10-14, wherein the social event calendar sharing service, when executed by the processing system, further: receives a request for a subscription to the event via the link; and provides the subscription for a subscriber.

### Example 16

The system according to example 15, wherein the social event calendar sharing service, when executed by the processing system, further: receives a modification of the event details for the event associated with the personal calendar; stores the modification of the event details; and provides the modification to the subscriber to the event.

### Example 17

One or more computer readable storage media having program instructions stored thereon, the program instructions comprising a link that, when executed by a processing system, directs the processing system to subscribe to a specific event associated with a personal calendar.

### Example 18

The one or more computer readable storage media according to example 17, wherein the link is not to a webpage.

### Example 19

The one or more computer readable storage media according to examples 17 or 18, wherein the link is comprises a shortened uniform resource locator (URL).

### Example 20

The one or more computer readable storage media according to any of examples 17-19, wherein the link is not to an iCalendar format file.

It should be understood that the examples and implementations described herein are for illustrative purposes only and that various modifications or changes in light thereof will be suggested to persons skilled in the art and are to be included within the spirit and purview of this application.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts that would be recognized by one skilled in the art are intended to be within the scope of the claims.

What is claimed is:

1. A method facilitating social calendar event sharing, the method comprising:
generating a link to a specific calendar event that is associated with a first personal calendar; and
responsive to receiving a request to add the specific calendar event to a second personal calendar via the link, providing a subscription to the specific calendar event for the second personal calendar.

2. The method of claim 1, further comprising:
receiving event details for the specific calendar event and a request to publish the specific calendar event, the generating of the link being performed in response to the request to publish the specific calendar event; and
storing the event details for the specific calendar event.

3. The method of claim 2, further comprising:
in response to receiving a modification of the event details for the specific calendar event, storing the modification of the event details for the specific calendar event and publishing the modification to the subscription.

4. The method of claim 1, wherein the second personal calendar is managed by a platform different than that of the personal calendar to which the specific calendar event is associated.

5. The method of claim 1, wherein the link is not to a webpage.

6. The method of claim 1, wherein the link is not to an iCalendar format file.

7. The method of claim 1, further comprising:
tracking at least one of views of the specific calendar event and subscriptions to the specific calendar event; and
providing results of the tracking as feedback to an owner of the specific calendar event.

8. The method of claim 7, wherein the feedback is platform independent.

9. The method of claim 7, wherein the feedback is received from multiple clients of at least two platforms.

10. A system comprising:
a social event calendar sharing service stored on one or more computer readable storage media that, when executed by a processing system:
receives an indication to generate a link to an event associated with a personal calendar and event details of the event;
stores the event details and generates the link;
stores an access indication for each access condition for the event details via the link; and
provides the access indication to an event owner.

11. The system of claim 10, wherein the access condition comprises at least one of a view of the event details, a click on the link, and a subscription to the event.

12. The system of claim 10, wherein the access indication comprises at least one of a number of views of the event details, a number of clicks on the link, and a number of subscriptions to the event.

13. The system of claim 10, wherein the link is not to a webpage.

14. The system of claim 10, wherein the link is not to an iCalendar format file.

15. The system of claim 10, wherein the social event calendar sharing service, when executed by the processing system, further:
receives a request for a subscription to the event via the link; and
provides the subscription for a subscriber.

16. The system of claim 15, wherein the social event calendar sharing service, when executed by the processing system, further:
receives a modification of the event details for the event associated with the personal calendar;
stores the modification of the event details; and
provides the modification to the subscriber to the event.

17. One or more computer readable storage media having program instructions stored thereon, the program instructions comprising a link that, when executed by a processing system, directs the processing system to subscribe to a specific event associated with a personal calendar.

18. The one or more computer readable storage media of claim 17, wherein the link is not to a webpage.

19. The one or more computer readable storage media of claim 17, wherein the link is comprises a shortened uniform resource locator (URL).

20. The one or more computer readable storage media of claim 17, wherein the link is not to an iCalendar format file.
